(19) United States
(12) Patent Application Publication
(10) Pub. No.: US 2014/0251267 A1
(43) Pub. Date: Sep. 11, 2014

(54) METHOD AND SYSTEM FOR IMPROVING ENGINE STARTING

(71) Applicant: FORD GLOBAL TECHNOLOGIES, LLC, Dearborn, MI (US)

(72) Inventors: Sam Hashemi, Farmington Hills, MI (US); Joe F. Stanek, Northville, MI (US); Donald Charles Franks, Linden, MI (US); John A. Lockwood, Canton, MI (US)

(73) Assignee: FORD GLOBAL TECHNOLOGIES, LLC, Dearborn, MI (US)

(21) Appl. No.: 13/789,047

(22) Filed: Mar. 7, 2013

(51) Int. Cl. F02D 13/02

(52) U.S. Cl. CPC F02D 13/02
USPC 123/345

(57) ABSTRACT

A system and method for operating an engine is described. In one example, engine boost pressure is adjusted to improve engine starting.

### BACKGROUND/SUMMARY

An engine may be automatically stopped during conditions where vehicle motion is not requested. For example, an engine may be stopped without a driver requesting engine stop when the vehicle in which the engine operates encounters a traffic signal. The engine may be stopped to conserve fuel. Further, while operating in an urban environment, the engine may be frequently stopped and restarted as the vehicle encounters an increased number of traffic signals and traffic congestion. If the engine restarts slowly and does not respond to driver torque demand in a timely manner, the driver may become aggravated. Additionally, repeated engine starting may degrade engine starter life. Consequently, repeatedly stopping and starting an engine may not be desirable if such conditions may not be overcome.

The inventors herein have recognized the above-mentioned limitations and have developed an engine operating method, comprising: opening a cylinder valve while engine rotation is stopped; increasing pressure in a cylinder of the engine while engine rotation is stopped; and directly starting the engine via providing spark and fuel in the cylinder.

By increasing air pressure in one or more engine cylinders while an engine is stopped, it may be possible to increase engine acceleration during direct engine starting so that the engine may respond more timely to an increase in driver demand torque. Further, since the engine may be directly started with a higher pressure in a cylinder, the engine starter may be engaged less frequently during engine starting. Consequently, starter degradation may be reduced and vehicle drivability may be improved.

The present description may provide several advantages. For example, the approach may improve engine torque response after an engine start. Additionally, the approach may improve engine durability. Further, the approach may improve engine emissions by providing more reliable engine starting.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an engine;

FIG. 2 shows an example engine starting boost valve;

FIG. 3 shows and example valve pattern for an engine cylinder;

FIGS. 4 and 5 show example engine stops and starts; and

FIG. 6 shows an example method for stopping and starting an engine.

### DETAILED DESCRIPTION

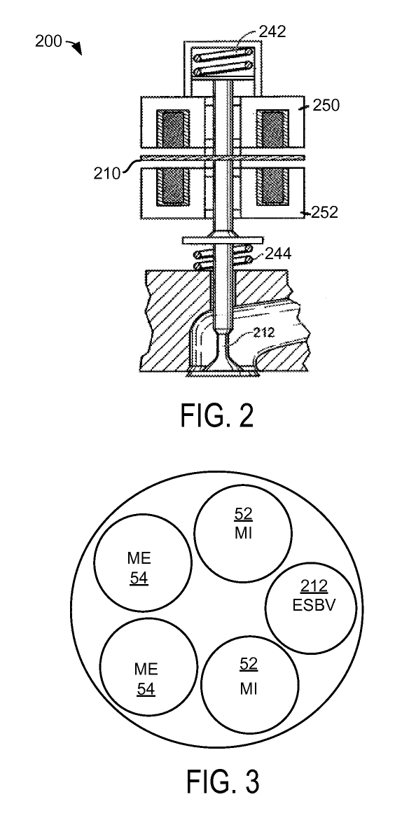

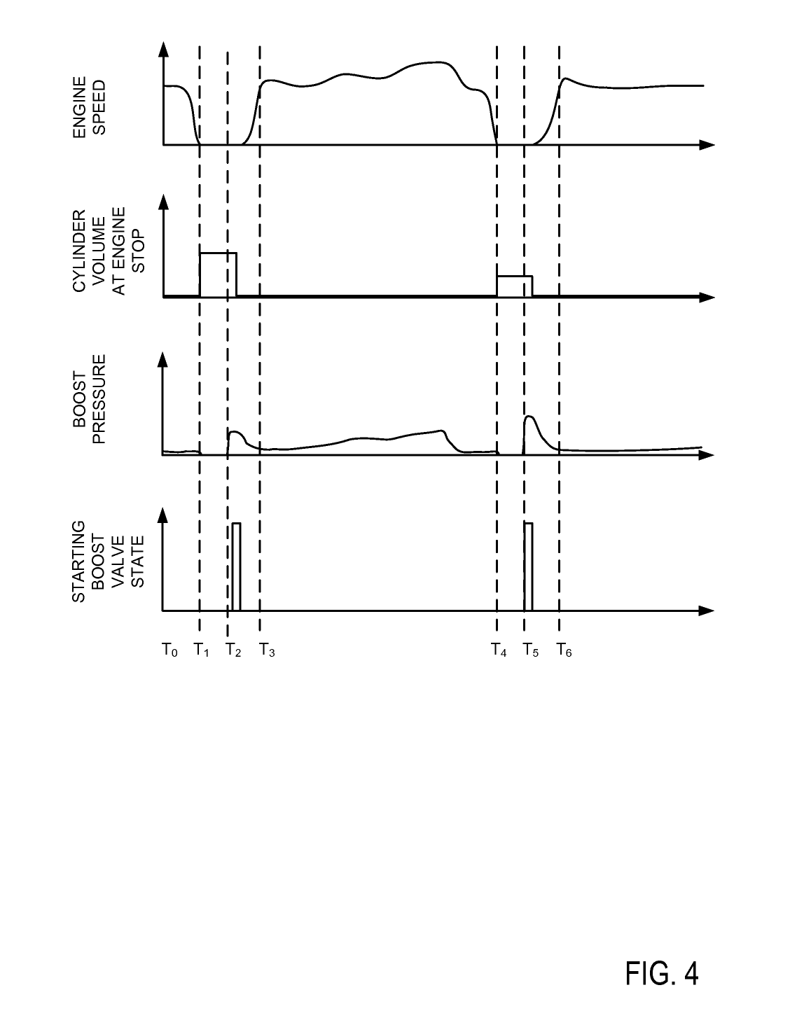

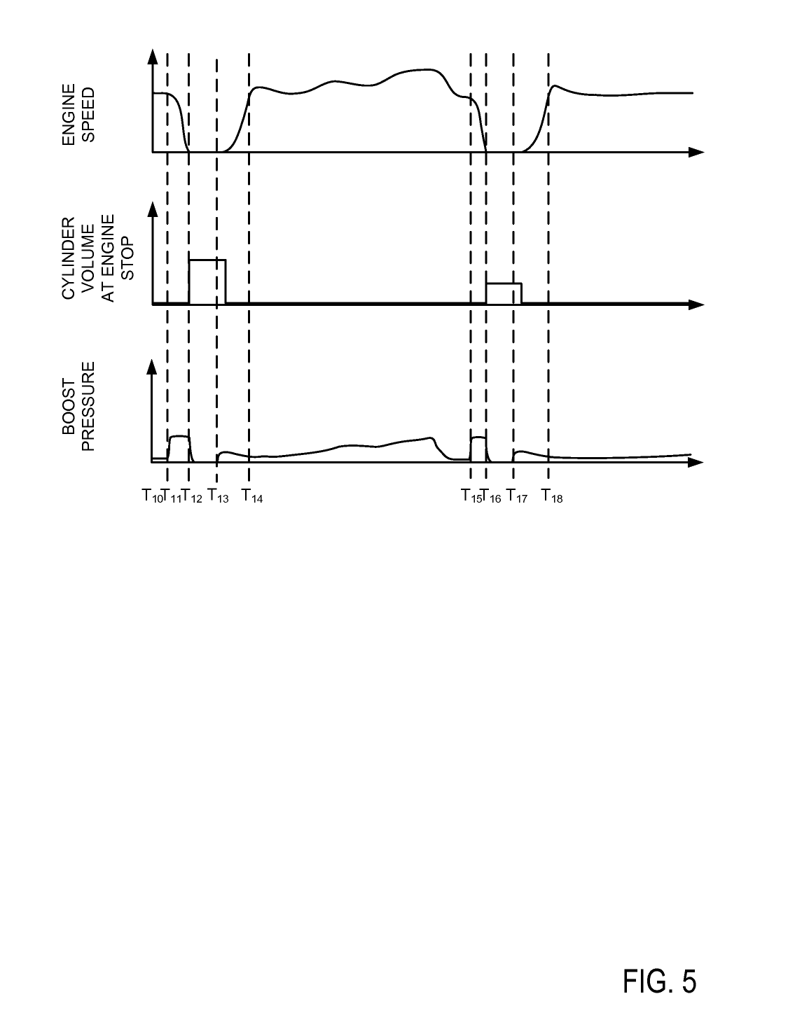

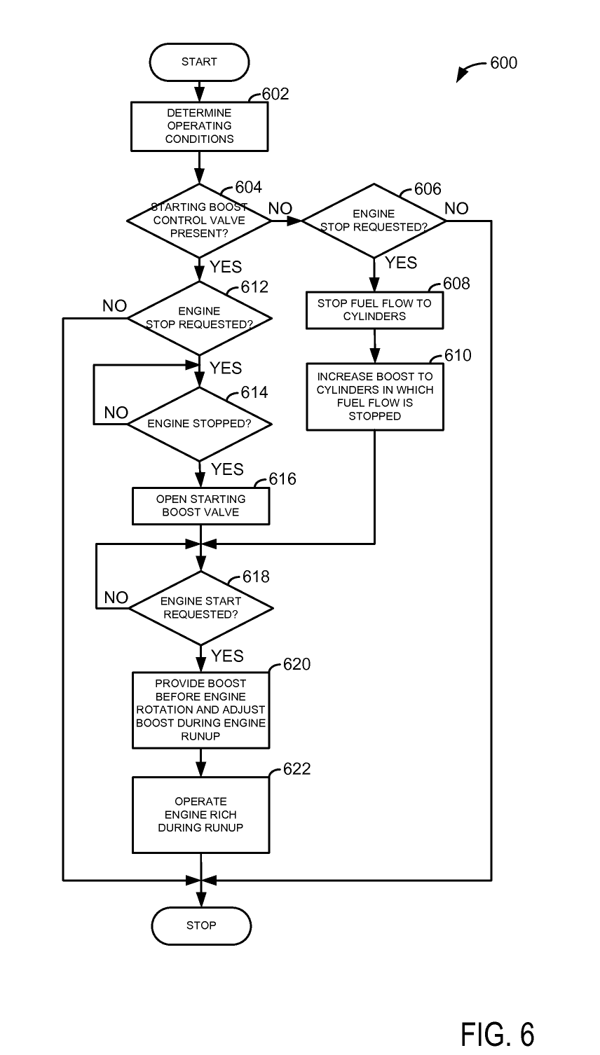

The present description is related to starting an engine. In one example, a turbocharger turbine rotates during an engine stop period to increase cylinder air charge for engine starting. Air may enter a cylinder while the engine is stopped via a valve as is shown in FIG. 2. The valve shown in FIG. 2 may be incorporated into a cylinder valve configuration as is shown in FIG. 3. The engine may be stopped and started as shown in FIGS. 4 and 5 according to the method of FIG. 6.

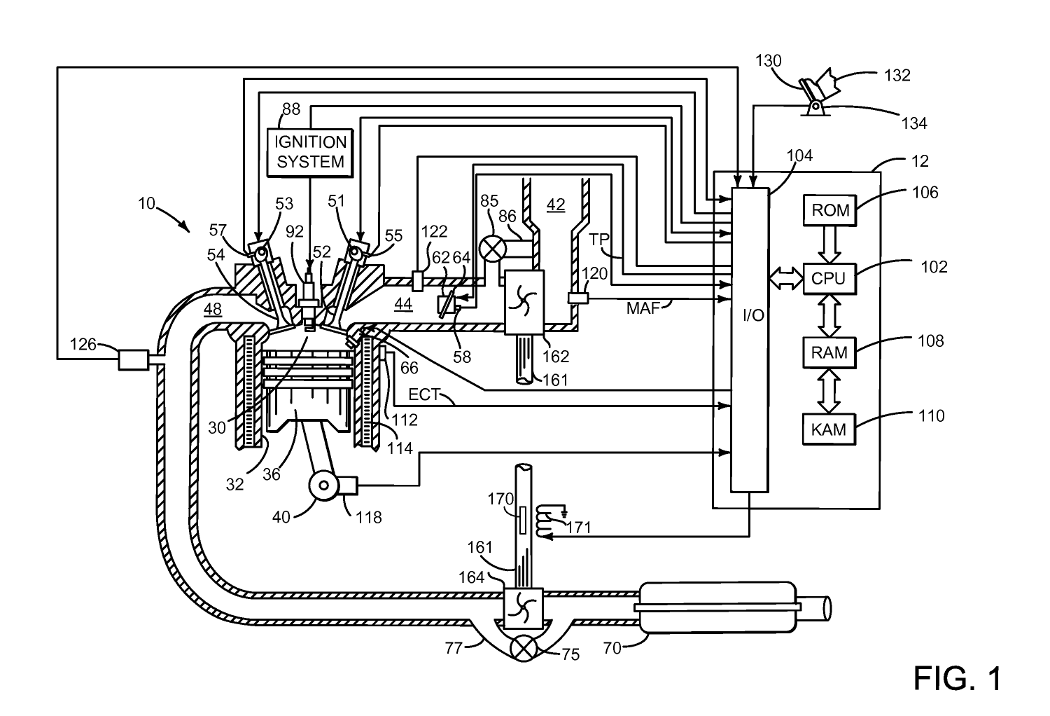

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57.

Fuel injector 66 is shown positioned to inject fuel directly into cylinder 30, which is known to those skilled in the art as direct injection. Alternatively, fuel may be injected to an intake port, which is known to those skilled in the art as port injection. Fuel injector 66 delivers liquid fuel in proportion to a pulse width provided by controller 12. Fuel is delivered to fuel injector 66 by a fuel system (not shown) including a fuel tank, fuel pump, and fuel rail (not shown).

Intake manifold 44 is supplied air by compressor 162. Compressor 162 provides boost (e.g., pressurized air) upstream of throttle 62. Pressurized air may enter intake manifold 44 when throttle 62 is at least partially opened. Exhaust gases rotate turbine 164 which is coupled to shaft 161, thereby driving compressor 162. In some examples, a bypass passage 77 is included so that exhaust gases may bypass turbine 164 during selected operating conditions. Flow through bypass passage 77 is regulated via waste gate 75. Further, a compressor bypass passage 86 may be provided in some examples to limit pressure provided by compressor 162. Flow though bypass passage 86 is regulated via valve 85. In this example, a first magnetic field is provided by windings, or alternatively permanent magnets, 170 coupled to shaft 161, and winding 171 provides a second magnetic field when supplied current via controller 12. The two magnetic fields can rotate or hold shaft 161 so as to control the rotational direction of compressor 162 and turbine 164. In addition, intake manifold 44 is shown communicating with central throttle 62 which adjusts a position of throttle plate 64 to control air flow from engine air intake 42. Central throttle 62 may be electrically operated.

Distributorless ignition system 88 provides an ignition spark to combustion chamber 30 for igniting an air-fuel mixture via spark plug 92 in response to controller 12. In other examples, the engine may be a compression ignition engine without an ignition system, such as a diesel engine. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing accelerator position adjusted by foot 132; a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

In some examples, the engine may be coupled to an electric motor/battery system in a hybrid vehicle. The hybrid vehicle may have a parallel configuration, series configuration, or variation or combinations thereof. Further, in some embodiments, other engine configurations may be employed, for example a diesel engine.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is described merely as an example, and that intake and exhaust valve opening and/or closing timings may vary, such as to provide positive or negative valve overlap, late intake valve closing, or various other examples.

Referring now to FIG. 2, a cross section of an engine starting boost valve is shown. The engine starting boost valve shown may be opened and closed during engine stopping and while the engine is stopped independent of other engine intake valves. Further, an engine starting boost valve may be present in each engine cylinder. Engine starting boost valve 200 is electrically operated and its operation is not dependent on crankshaft or camshaft position. In other example, engine starting boost valve 200 may be mechanically operated.

Engine starting boost valve (ESBV) 200 includes an armature 210 that may be drawn toward closing coil 250 when current passes through closing coil 250. Armature 210 may be drawn toward opening coil 252 when current passes through closing coil 252. Springs 242 and 244 apply force to armature 210 such that poppet valve 212 is in a partially open position when no current passes through coils 250 and 252. Poppet valve 212 opens and closes to affect air flow into combustion chamber 30 shown in FIG. 1.

Turning now to FIG. 3 an example plan view layout for valves in a cylinder head of a cylinder is shown. Mechanical exhaust valves 54 may open and close to allow exhaust gases to exhaust manifold 48 shown in FIG. 1. Mechanical intake valves 52 may open and close to allow air flow into combustion chamber 30 shown in FIG. 1. Poppet valve 212 of engine starting boost valve may be selectively opened during engine stopping and starting to allow boosting of pressure in the cylinder during starting.

The system of FIGS. 1-3 provides for an engine system, comprising: an engine including a cylinder, a valve, and a turbocharger; and a controller including executable instructions stored in non-transitory memory for adjusting engine boost pressure in response to cylinder volume of the cylinder at engine stop. The engine system includes where the executable instructions include instructions for increasing the engine boost pressure as the cylinder volume decreases. The engine system includes where the executable instructions include instructions for decreasing the engine boost pressure as the cylinder volume increases. The engine system further comprises additional executable instructions to open a valve to increase pressure in the cylinder during the engine stop. The engine system includes where the executable instructions increase the engine boost pressure while the engine is stopped. The engine system further comprises additional executable instructions for directly starting the engine.

Referring now to FIG. 4, a plot of selected parameters of interest during engine stopping and starting are shown. The sequence of FIG. 4 may be provided via the system of FIGS. 1-3 according to the method of FIG. 6.

The first plot from the top of FIG. 6 shows engine speed versus time. The X axis represents time and time increases from the left hand side of the figure to the right hand side of the figure. The Y axis represents engine speed and engine speed increases in the direction of the Y axis arrow.

The second plot from the top of FIG. 6 shows volume of a cylinder at a time of engine stop versus time. The X axis represents time and time increases from the left hand side of the figure to the right hand side of the figure. The Y axis represents volume of a cylinder at a time of engine stop and cylinder volume speed increases in the direction of the Y axis arrow. The cylinder volume may be greater when a piston of the cylinder is at bottom-dead-center as compared to when the piston is at top-dead-center.

The third plot from the top of FIG. 6 shows engine boost pressure versus time. The X axis represents time and time increases from the left hand side of the figure to the right hand side of the figure. The Y axis represents engine boost pressure and engine boost pressure increases in the direction of the Y axis arrow.

The fourth plot from the top of FIG. 6 shows engine starting boost valve state versus time. The X axis represents time and time increases from the left hand side of the figure to the right hand side of the figure. The Y axis represents engine starting boost valve state and engine starting boost valve state is open when the trace is at a higher level. The engine starting boost valve is closed when the engine starting boost valve state is at a lower level.

At time T₀, the engine speed is elevated indicating that the engine is operating. The cylinder volume at engine stop is zero since the engine is running and not stopped. The engine boost pressure is low indicating that the driver demand torque (not shown) is at a low level. The engine starting boost valve state is at a low level indicating that the engine starting boost valve is closed during engine operation.

At time T₁, engine speed is zero in response to an engine stop request. The engine stop request may be initiated via a driver, or alternatively, automatically without the driver asserting an input that has a sole purpose of stopping and/or starting the engine. The cylinder volume at time of engine stop increases to a medium level to indicate that the piston in the cylinder is near bottom-dead-center. The engine boost pressure is reduced to zero since the engine is stopped. The engine starting boost valve is shown being held in a closed state at the time of engine stop. However, in other examples, the engine starting boost valve may be opened when the engine stops rotating or during engine rundown after fuel flow to the engine ceases.

At time T₂, engine boost pressure is increased and the engine starting boost valve is opened in response to a request to start the engine (not shown). The engine start request may be initiated via a driver or automatically via a controller. By increasing boost pressure, pressure in the cylinder may be increased so that when fuel is added to the cylinder, pressure in the cylinder post combustion is increased as compared to when the engine starts with a cylinder pressure that is based on barometric pressure. The engine starting boost valve opens and closes without the engine rotating. However, in some examples where the engine is not direct started, the boost pressure may be increased and air admitted to the cylinder via intake valves or ESBV as the engine begins to rotate before combustion in engine cylinders is initiated.

Between time T₂ and time T₃, the boost pressure is decreased between the time the engine is stopped and a time the engine reaches a threshold speed (e.g., idle speed). The cylinder volume at engine stop transitions to a lower level indicating that the engine is rotating and cylinder volume at engine stop has no meaning when the engine is rotating.

At time T₃, the engine speed reaches a threshold speed and the boost pressure is adjusted based on driver demand torque from this time until the engine is stopped at time T₄. The engine starting boost valve remains in a closed state and engine speed varies with driving conditions.

At time T₄, engine speed is zero in response to an engine stop request. The cylinder volume at time of engine stop increases to a lower level to indicate that the piston in the cylinder is near top-dead-center. Thus, the cylinder volume at time T₄ is less than the cylinder volume at time T₁. The engine boost pressure is reduced to zero since the engine is stopped. The engine starting boost valve is shown being held in a closed state at the time of engine stop.

At time T₅, engine boost pressure is increased and the engine starting boost valve is opened in response to a request to start the engine (not shown). The engine boost pressure at time T₅ is increased in response to cylinder volume at time T₅ which is less than cylinder volume at time T₁. By increasing the boost pressure further at time T₅, a denser air-fuel mixture may be provided into a smaller volume. Consequently, engine torque produced via combusting the mixture may be increased as compared to combusting a less dense air-fuel mixture. The engine starting boost valve opens and closes without the engine rotating.

Between time T₅ and time T₆, the boost pressure is decreased between the time the engine is stopped and a time the engine reaches a threshold speed (e.g., idle speed). The cylinder volume at engine stop transitions to a lower level indicating that the engine is rotating and cylinder volume at engine stop has no meaning when the engine is rotating.

At time T₆, the engine speed reaches a threshold speed and the boost pressure is adjusted based on driver demand torque from this time until the engine is stopped again. The engine starting boost valve remains in a closed state and engine speed varies with driving conditions.

Referring now to FIG. 5, another example engine stopping and starting sequence is shown. The sequence of FIG. 5 may be provided via the system of FIGS. 1-3 according to the method of FIG. 6.

The plots of FIG. 5 illustrate the same variables as the plots shown in FIG. 4; however, FIG. 5 illustrates example engine starts and stops without an engine starting boost valve. Therefore, for the sake of brevity, a description of each plot is omitted.

At time T₁₀, the engine is operating and combusting an air-fuel mixture. The boost pressure is low indicating that the driver demand torque is low (not shown). The cylinder volume at engine stop is also at a lower level indicating that the engine is running.

At time T₁₁, an engine stop request is made. The engine stop request may be automatically generated by a controller without driver input to a device that has a sole purpose of starting and/or stopping the engine (e.g., an ignition switch). The engine stop request may be initiated when vehicle speed is zero and when a brake pedal is depressed, for example. Fuel supplied to the engine is stopped in response to the engine stop request.

Between time T₁₁ and time T₁₂, the boost pressure is increased in response to the engine stop request. Increasing the boost pressure allows more air to be pumped into the engine during engine stopping so that the engine may be restarted with a higher cylinder charge. The higher cylinder charge may accelerate the engine at a higher rate and reduce the engine's torque response time since the engine may arrive at operating speed sooner. In one example, the boost pressure may be increased and coordinated with a throttle opening time so that the engine intake manifold fills with higher pressure air when a selected cylinder's intake valves open during engine stopping. The intake valves close and the engine stops before the exhaust valves are opened. Subsequently, fuel may be supplied to the cylinder and ignited to directly start the engine without assistance from a starter. In this way, an increased air charge may be trapped in a cylinder when the engine is stopped so that the engine may start with greater acceleration. The boost pressure may be increased via closing a waste gate or by increasing electrical assistance to the turbocharger.

At time T₁₂, the engine is stopped and the boost pressure is reduced in response to the engine stopping. Reducing the boost pressure may reduce energy consumption by not using energy to create boost when it is not needed. The cylinder volume for a particular engine cylinder also increases at time T₁₂ to show that the cylinder's piston is near bottom-dead-center where cylinder volume is greatest.

At time T₁₃, an engine start request is received and the boost pressure is increased in response to the engine start request (not shown). The engine start request may be initiated by the driver or automatically by a controller without a driver directly requesting an engine start via an input that has a sole function of starting and/or stopping the engine (e.g., an ignition switch). The boost pressure is increased to increase pressure in cylinders that will induct air after engine rotation begins. In one example, the boost pressure is adjusted to be a single pressure independent of barometric pressure. Spark and fuel are supplied to the engine cylinder or cylinders that are trapping an air charge at the time of engine stop to directly start the engine without a starter.

Between time T₁₃ and time T₁₄, the engine rotates and inducts air at a higher pressure than atmospheric pressure. The increased air pressure allows the engine to accelerate at a greater rate than if the engine were inducting air a barometric pressure. Further, the boost amount is reduced as engine speed approaches idle speed to control any engine speed flare.

At time T₁₄, the engine reaches a threshold speed (e.g., idle speed) and boost pressure is reduced to a lower level suitable for idle conditions. The boost pressure is further adjusted in response to driver demand torque to provide an engine air charge that provides the desired engine torque.

At time T₁₅, an engine stop request is made. Fuel supplied to the engine is stopped in response to the engine stop request. Consequently, engine speed is reduced toward zero speed.

Between time T₁₅ and time T₁₆, the boost pressure is increased in response to the engine stop request. Increasing the boost pressure allows more air to be pumped into the engine during engine stopping so that the engine may be restarted with a higher cylinder charge. The higher cylinder charge may accelerate the engine at a higher rate and reduce the engine's torque response time since the engine may arrive at operating speed sooner. The boost pressure may be increased and coordinated with a throttle opening time so that the engine intake manifold fills with higher pressure air when a selected cylinder's intake valves open during engine stopping. The intake valves close and the engine stops before the exhaust valves are opened. Subsequently, fuel may be supplied to the cylinder and ignited to directly start the engine without assistance from a starter. The boost pressure may be increased via closing a waste gate or by increasing electrical assistance to the turbocharger.

At time T₁₆, the engine is stopped and the boost pressure is reduced in response to the engine stopping. Reducing the boost pressure may reduce energy consumption by not using energy to create boost when it is not needed. The cylinder volume for a particular engine cylinder also increases at time T₁₆ to show that the cylinder's piston is near top-dead-center where cylinder volume is least. However, since this example does not include an engine starting boost valve and since the cylinder inducted air while boost was increased between times T₁₅ and T₁₆, fuel injected during the engine restart at time T₁₇ is equivalent to fuel injected at time T₁₃, excepting for accommodations for changes in engine temperature.

At time T₁₇, an engine start request is received and the boost pressure is increased in response to the engine start request (not shown). The engine start request may be initiated by the driver or automatically by a controller without a driver directly requesting an engine start via an input that has a sole function of starting and/or stopping the engine (e.g., an ignition switch). The boost pressure is increased to increase pressure in cylinders that will induct air after engine rotation begins. Spark and fuel are supplied to the engine cylinder or cylinders that are trapping an air charge at the time of engine stop to directly start the engine without a starter.

Between time T₁₇ and time T₁₈, the engine rotates and inducts air at a higher pressure than atmospheric pressure. The increased air pressure allows the engine to accelerate at a greater rate than if the engine were inducting air a barometric pressure. Further, the boost amount is reduced as engine speed approaches idle speed to control any engine speed flare.

At time T₁₈, the engine reaches a threshold speed (e.g., idle speed) and boost pressure is reduced to a lower level suitable for idle conditions. The boost pressure is further adjusted in response to driver demand torque to provide an engine air charge that provides the desired engine torque.

Referring now to FIG. 6, a method for stopping and starting an engine is shown. The method of FIG. 6 may be applied to engines that are automatically stopped and started as well as engine that are stopped and started by a driver. The method of FIG. 6 may be provided as executable instructions stored in non-transitory memory of controller 12 shown in FIG. 1.

At 602, method 600 determines operating conditions. Operating conditions may include but are not limited to engine speed, engine load, engine temperature, vehicle speed, brake pedal position, and ambient temperature. Method 600 proceeds to 604 after operating conditions are determined.

At 604, method 600 judges whether or not an engine starting boost control valve is present. In one example, a bit programmed in memory identifies whether or not an engine starting boost control valve is present. If method 600 judges that an engine starting boost valve is present, the answer is yes and method 600 proceeds to 612. Otherwise, the answer is no and method 600 proceeds to 606.

At 606, method 600 judges whether or not an engine stop has been requested. An engine stop request may be made automatically via an engine controller without a driver directly providing input to a device that has a sole purpose of starting and/or stopping the engine (e.g., an ignition switch). For example, a controller may request an engine stop when a driver applies a vehicle brake pedal and when vehicle speed is zero. Alternatively, an engine stop may be requested by a driver. If method 600 judges that an engine stop request is present, the answer is yes and method 600 proceeds to 608. Otherwise, the answer is no and method 600 proceeds to exit.

At 608, method 600 stops fuel flow to engine cylinders. Further, in some examples, spark may cease to be supplied to engine cylinders so that combustion is stopped in engine cylinder. Method 600 proceeds to 610 after combustion and fuel flow to engine cylinders is stopped.

At 610, method 600 increases boost to the engine and cylinders. Boost is increased and a throttle may be opened at a selected time or engine position so that cylinders in which fuel flow is stopped receive an increased air amount. The increased air amount is inducted into engine cylinders as the engine rotates. The air may be trapped in one or more cylinders when the engine stops. The air is trapped in a cylinder when the engine stops and the cylinder is on a compression or expansion stroke. Cylinder intake and exhaust valves are closed during the compression and expansion strokes so as to trap the air in the cylinder. In one example, boost may be increased via closing a waste gate or compressor bypass valve. Closing the waste gate or the compressor bypass valve allows additional air to enter the area between the compressor and the throttle. In other examples, boost may be increased via increasing speed of an electrically assisted turbocharger. Method 600 proceeds to 618 after boost pressure is increased during engine stopping in response to the engine stop request.

At 612, method 600 judges whether or not an engine stop has been requested. The engine stop request may be made automatically via an engine controller without a driver directly providing input to a device that has a sole purpose of starting and/or stopping the engine (e.g., an ignition switch). Alternatively, an engine stop may be requested by a driver. If method 600 judges that an engine stop request is present, the answer is yes and method 600 proceeds to 614. Otherwise, the answer is no and method 600 proceeds to exit.

At 614, method 600 judges whether or not the engine is stopped. The engine may be judges stopped when engine speed is zero. If method 600 judges that the engine is stopped, the answer is yes and method 600 proceeds to 616. Otherwise, the answer is no and method 600 returns to 614. It should also be mentioned that in some examples the engine starting boost valve may be opened in response to the engine stop request as engine speed decelerates to zero.

At 616, method 600 opens the engine starting boost valve so that when boost pressure is increased, pressure in a cylinder may be increased. For example, an engine starting boost valve of a cylinder may be opened when the engine is stopped and the cylinder is on a compression or expansion stroke. In some examples, the engine starting boost valve may be opened in response to an engine start request. Method 600 proceeds to 618 after the engine starting boost valve is opened.

At 618, method 600 judges whether or not an engine start request is present. An engine start request may be made automatically via a controller without direct driver input to a device that has a sole purpose of starting and/or stopping the engine. Alternatively, a driver may request an engine start via starter switch, for example. If an engine start request is not present, the answer is no and method 600 returns to 618. Otherwise, the answer is yes and method 600 proceeds to 620.

At 620, method 600 increases engine boost in response to the engine start request. In one example, the boost is increased when the engine is stopped via an electrically assisted turbocharger. In other examples, boost may be increased as the engine starts to rotate. If the engine includes one or more engine starting boost valves, the engine starting boost valve is closed after a desired pressure is present in the engine cylinder. In one example, method 600 judges whether or not a desired pressure is in a cylinder based on intake manifold pressure. The boost pressure may be varied based on volume of a selected cylinder at engine stop. In one example, the boost pressure is increased for smaller cylinder volumes. The boost pressure is decreased for larger cylinder volumes. For example, if a piston in a selected cylinder is near top-dead-center and the cylinder's volume is presently relatively small, the boost pressure is increased as compared to when the cylinder's volume is large. On the other hand, if the piston in the selected cylinder is near bottom-dead-center and the cylinder's volume is presently relatively large while the engine is stopped, the boost pressure is decreased as compared to when the cylinder's volume is small.

The engine may also be directly started at 620 via supplying spark and fuel to a cylinder in which air is trapped. Since the intake passage is boosted, the cylinder holds more air and therefore additional fuel may be supplied to the cylinder so that the cylinder produces additional torque as compared to when air at atmospheric pressure is inducted to the cylinder.

Method 600 also adjusts boost during engine run-up (e.g., when the engine accelerates from zero speed to idle speed). In particular, boost is reduced as the engine rotates and accelerates to a predetermined speed. By reducing boost during run-up, the possibility of engine speed overshoot may be reduced. Method 600 proceeds to 622 after engine boost is adjusted.

At 622, method 600 operates the engine with a rich air fuel mixture. The rich air fuel mixture improves engine starting robustness, and since boost pressure is increased, air may pass through exhaust valves into the exhaust manifold during valve overlap to provide an exothermic reaction in the exhaust manifold. Further, when the air and rich exhaust gases meet in the exhaust manifold, a lean overall mixture that facilitates oxidation may be produced. Method 600 proceeds to exit after the engine is operated rich. It should also be mention that during some conditions, the engine may be operated lean if desired.

Thus, the method of FIG. 6 provides for a method, comprising: opening a cylinder valve while engine rotation is stopped; increasing pressure in a cylinder of the engine while engine rotation is stopped; and directly starting the engine via providing spark and fuel in the cylinder. The engine operating method includes where increasing pressure in the cylinder includes increasing pressure in the cylinder via a compressor. The engine operating method also includes where the compressor is part of a turbocharger, and where the turbocharger is electrically assisted.

In some examples, the engine operating method further comprises opening a valve of the cylinder while the engine is stopped. The engine operating method further comprises closing the valve of the cylinder before directly starting the engine. The engine operating method includes where directly starting the engine includes starting the engine without assistance of a starter motor. The engine operating method includes where pressure in the cylinder is increased after the engine has been stopped for a predetermined amount of time, the predetermined amount of time based on a pressure decay time of the cylinder.

In another example, the method of FIG. 6 provides a method, comprising: increasing boost pressure of the engine in response to an engine stop request; stopping engine rotation; and providing spark and fuel to a cylinder in response to an air charge of the cylinder while engine rotation is stopped. The method includes where boost pressure is increased via increasing compressor output. The method includes where compressor output is increased via electrical power. The method includes where compressor output is increased via closing a waste gate. The method further comprises increasing boost pressure in response to a request to start the engine while engine rotation is stopped. The method further comprises decreasing boost pressure during engine run-up. The method includes where boost pressure is decreased between zero engine speed and engine idle speed.

As will be appreciated by one of ordinary skill in the art, the method described in FIG. 6 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, single cylinder, I2, I3, I4, I5, V6, V8, V10, V12 and V16 engines operating on natural gas, gasoline, diesel, or alternative fuel configurations could use the present description to advantage.

1. An engine operating method, comprising:
opening a cylinder valve while engine rotation is stopped;
increasing pressure in a cylinder of the engine while engine rotation is stopped; and
directly starting the engine via providing spark and fuel in the cylinder.

2. The engine operating method of claim 1, where increasing pressure in the cylinder includes increasing pressure in the cylinder via a compressor.

3. The engine operating method of claim 2, where the compressor is part of a turbocharger, and where the turbocharger is electrically assisted.

4. The engine operating method of claim 1, where the cylinder valve is an engine starting boost valve.

5. The engine operating method of claim 4, further comprising closing the engine starting boost valve before directly starting the engine.

6. The engine operating method of claim 1, where directly starting the engine includes starting the engine without assistance of a starter motor.

7. The engine operating method of claim 1, where pressure in the cylinder is increased after the engine has been stopped for a predetermined amount of time, the predetermined amount of time based on a pressure decay time of the cylinder.

8. An engine operating method, comprising:
increasing boost pressure of the engine in response to an engine stop request;
stopping engine rotation; and
providing spark and fuel to a cylinder in response to an air charge of the cylinder while engine rotation is stopped.

9. The method of claim 8, where boost pressure is increased via increasing compressor output.

10. The method of claim 9, where compressor output is increased via electrical power.

11. The method of claim 9, where compressor output is increased via closing a waste gate.

12. The method of claim 8, further comprising increasing boost pressure in response to a request to start the engine while engine rotation is stopped.

13. The method of claim 12, further comprising decreasing boost pressure during engine runup.

14. The method of claim 13, where boost pressure is decreased between zero engine speed and engine idle speed.

15. An engine system, comprising:
an engine including a cylinder, a valve, and a turbocharger; and
a controller including executable instructions stored in non-transitory memory for adjusting engine boost pressure in response to cylinder volume of the cylinder at engine stop.

16. The engine system of claim 15, where the executable instructions include instructions for increasing the engine boost pressure as the cylinder volume decreases.

17. The engine system of claim 14, where the executable instructions include instructions for decreasing the engine boost pressure as the cylinder volume increases.

18. The engine system of claim 15, further comprising additional executable instructions to open a valve to increase pressure in the cylinder during the engine stop.

19. The engine system of claim 15, where the executable instructions increase the engine boost pressure while the engine is stopped.

20. The engine system of claim 15, further comprising additional executable instructions for directly starting the engine.
